(19) United States
(12) Patent Application Publication
(10) Pub. No.: US 2025/0373923 A1
(43) Pub. Date: Dec. 4, 2025

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: Wataru MATSUURA, Kanagawa (JP)

(21) Appl. No.: 19/218,886

(22) Filed: May 27, 2025

(30) Foreign Application Priority Data
May 29, 2024 (JP) 2024-087244

(51) Int. Cl. H04N 23/61; G06T 7/12; G06V 20/70

(52) U.S. Cl. CPC H04N 23/61; G06T 7/12; G06V 20/70; G06V 2201/07

(57) ABSTRACT

An information processing apparatus that generates learning data, the apparatus comprises a position information obtaining unit configured to obtain focus position information of an image capturing unit; an image obtaining unit configured to obtain one or more images based on a point in time at which the focus position information was obtained; a defocus information obtaining unit configured to obtain defocus information at a point in time that is in temporal proximity to the point in time at which the focus position information was obtained; and a generation unit configured to determine, based on the obtained defocus information, a defocus amount of an object to be set as a main subject, and generate the learning data in which the defocus amount of the main subject is added as annotation information to the obtained one or more images obtained.

### BACKGROUND

### Field of the Technology

The present disclosure relates to an information processing apparatus, a control method of an information processing apparatus, and a storage medium.

### Description of the Related Art

In recent years, artificial intelligence (AI) has been increasingly put to use in various fields. In particular, there is supervised learning in which machine learning is performed based on teaching data including correct answer data, thereby generating an inference model.

In order to obtain a model supervised learning having a high generalization performance in machine learning, various inputs determined by a task to be solved, and high-quality teaching data in which annotation information is added to such inputs are required. In general, for high-quality teaching data, a published data set created for the purpose of a competition or the like can be used. However, if there is no teaching data suited for the purpose, users need to create a data set by themselves. In a case where a user creates a data set by him/herself, it is necessary to perform an annotation operation of adding annotation information by a manual operation or the like to create teaching data. Since it requires an enormous amount of teaching data to create a machine learning model having a high generalization performance, annotation requires a large amount of time.

Japanese Patent No. 7055259 discloses a method in which learning data is generated by semi-automatically or automatically performing annotation using a trained object detector.

However, the technique disclosed in Japanese Patent No. 7055259 is problematic in that a user needs to prepare image data by him/herself in order to generate learning data, and it is necessary to perform image capturing and collect image data, and therefore it requires time and effort to create learning data.

### SUMMARY

The present disclosure has been made in view of the above-described problems, and provides a technique for reducing the time and effort to generate learning data.

According to one aspect of the present disclosure, there is provided an information processing apparatus that generates learning data, the apparatus comprising: a position information obtaining unit configured to obtain focus position information of an image capturing unit; an image obtaining unit configured to obtain one or more images based on a point in time at which the focus position information was obtained; a defocus information obtaining unit configured to obtain defocus information at a point in time that is in temporal proximity to the point in time at which the focus position information was obtained; and a generation unit configured to determine, based on the defocus information obtained by the defocus information obtaining unit, a defocus amount of an object to be set as a main subject, and generate the learning data in which the defocus amount of the main subject is added as annotation information to the one or more images obtained by the image obtaining unit.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a hardware configuration diagram of a learning data generation apparatus according to a first embodiment.

FIG. 2 is a diagram illustrating a functional configuration of the learning data generation apparatus according to the first embodiment.

FIG. 3 is a flowchart illustrating a procedure of learning data generation processing according to the first embodiment.

FIGS. 4A to 4C are diagrams illustrating the learning data generation processing according to the first embodiment.

FIG. 5 is a flowchart illustrating a procedure of learning data generation processing according to Modification 1 of the first embodiment.

FIG. 6 is a diagram illustrating the learning data generation processing according to Modification 1 of the first embodiment.

FIG. 7 is a flowchart illustrating a procedure of learning data generation processing according to a second embodiment.

FIG. 8 is a diagram illustrating a functional configuration of a learning data generation apparatus according to the second embodiment.

FIGS. 9A to 9D are diagrams illustrating the learning data generation processing according to the second embodiment.

FIG. 10 is a diagram illustrating a functional configuration of a learning data generation apparatus according to a third embodiment.

FIG. 11 is a flowchart illustrating a procedure of the learning data generation processing according to the third embodiment.

FIG. 12 is a flowchart illustrating a procedure of the learning data generation processing according to the third embodiment.

FIGS. 13A to 13C are diagrams illustrating the learning data generation processing according to the third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

In the present embodiment, a description will be given of a case where learning data is generated, taking, as an example, image capturing performed with a lens-replaceable digital camera.

### <Hardware Configuration>

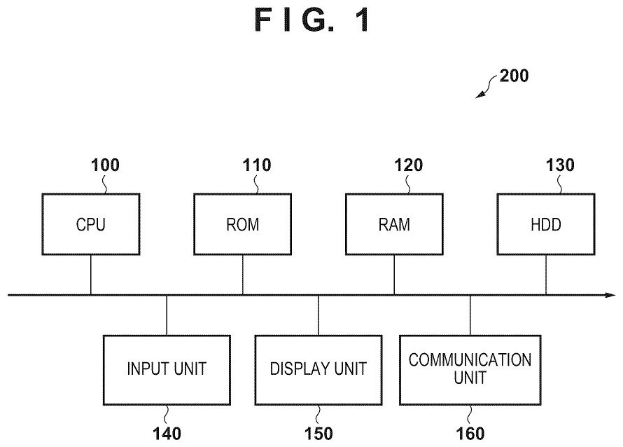

FIG. 1 shows an exemplary hardware configuration of an information processing apparatus (learning data generation apparatus 200) according to the present embodiment. A CPU 100 is a central processing unit, and performs calculation, logical determination, and the like for various types of processing. A control program is stored in a read-only-memory (ROM) 110. A random access memory (RAM) 120 is used as a temporary storage area such as a main memory of the CPU 100, and a work area. An HDD 130 is a hard disk for storing electronic data, a program, and the like according to the present embodiment. An external storage device may be used as a component that performs the same function. Here, the external storage apparatus can be implemented by, for example, a medium (recording medium) and an external storage drive for achieving access to the medium. As such a medium, a flexible disk (FD), a CD-ROM, a DVD, a USB memory, an MO, and a flash memory, for example, are known. The external storage apparatus may be a server apparatus or the like that is connected via a network.

An input unit 140 is constituted by a keyboard, a touch panel, or the like, and receives input from a user. A display unit 150 is constituted by a liquid crystal display or the like, and can display various types of data and processing results to the user. The learning data generation apparatus 200 can communicate with other devices via a communication unit 160. Instructions from the user may be received from other devices via the communication unit 160, or processing results may be output to other devices. The learning data generation apparatus 200 can be configured using an general-purpose information processing apparatus including the above-described configuration.

### <Functional Configuration>

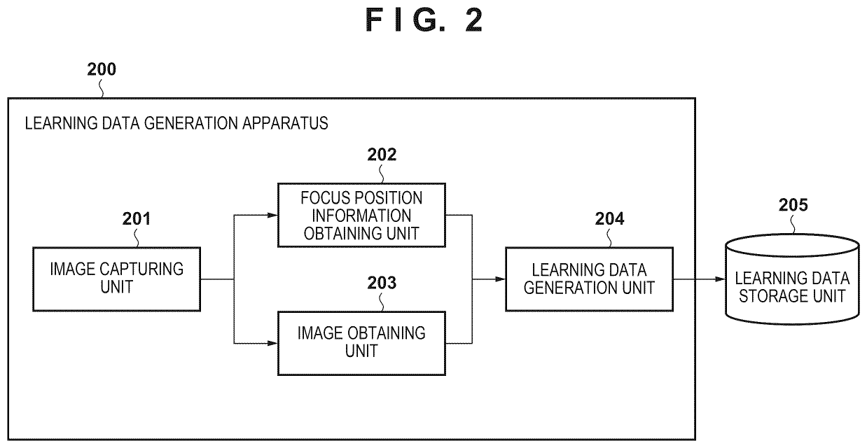

FIG. 2 is a diagram illustrating the learning data generation apparatus 200 according to the present embodiment. An image capturing unit 201 captures images of a subject. The image capturing unit 201 can be constituted by, for example, an imaging element such as a CMOS sensor. A focus position information obtaining unit 202 obtains focus position information that has been input by the user and received through the input unit 140. The focus position information that has been input by the user refers to coordinates indicating a position in a displayed image (in the angle of view of the image capturing unit 201) at which a distance measurement point (AF frame) to be focused on is selected (touch AF) through a touch operation. Other methods of selecting the AF frame may include a method (touch-and-drag AF) in which the AF frame is dragged using a touch panel or a joystick (multicontroller) and input. Alternatively, a method (gaze input) in which the AF frame is selected by the user operating a pointer using his or her line of sight may be used, for example.

An image obtaining unit 203 obtains an image captured by the image capturing unit 201. The obtained image includes a live-view image, and the timing of obtaining the image is not dependent on a release operation performed by the user. Based on the focus position information obtained by the focus position information obtaining unit 202, annotation information is added to the image obtained by the image obtaining unit 203. A learning data storage unit 205 stores learning data generated by a learning data generation unit 204.

### <Processing>

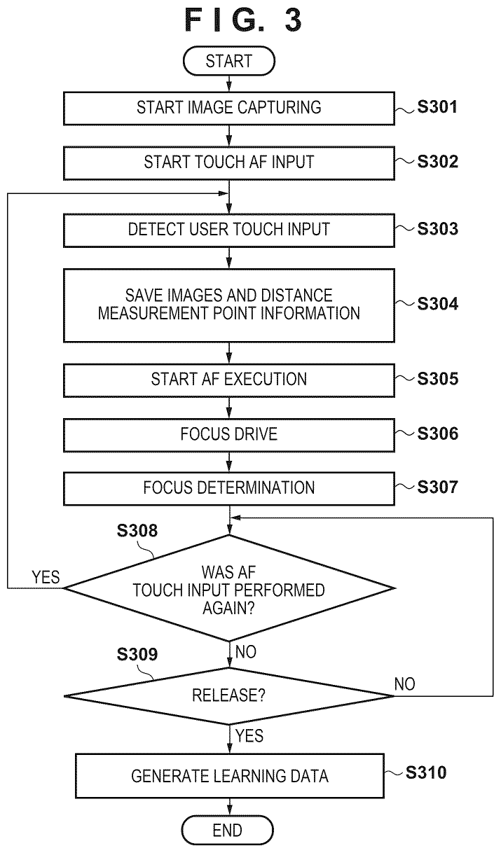

FIG. 3 shows a flowchart of the overall learning data generation processing according to the present embodiment. In S301, the image capturing unit 201 starts image capturing. A live-view image captured by the image capturing unit 201 is displayed in the display unit 150.

In S302, the image capturing unit 201 activates a touch AF capturing mode, which is a method by which the user selects an AF frame during autofocus (AF). The input unit 140 stands by to receive a touch input from the user.

In S303, the input unit 140 receives a touch input from the user. The touch input is performed by the user touching a position to be focused on within a touch panel of the input unit 140 while checking the live-view image displayed in the display unit 150.

In S304, the focus position information obtaining unit 202 obtains the coordinates (focus position information) of the touch input that have been input in S303. The image obtaining unit 203 saves the live-view image of the image capturing unit 201 at the moment when the touch input was performed in S303. The timing of saving the live-view image may be a moment when processing of confirming the touch input using a given button operation was performed, such as when a shutter button was pressed halfway after the touch input had been performed.

In S305, the image capturing unit 201 starts autofocus processing. Upon completion of the touch input in S303, processing of executing autofocus is started. In S306, the image capturing unit 201 drives a focus lens through the autofocus processing in S305. In S307, the image capturing unit 201 determines that the subject is in focus in a case where the position designated in S303 has been focused on as a result of the focus driving in S306.

In S308, the input unit 140 determines whether the user has performed a touch input again. If the determination in this step is Yes, the procedure returns to S303. On the other hand, if the determination in this step is No, the procedure proceeds to S309. The result of the focusing in S307 is confirmed by the user, and if it is determined that a desired subject is in focus, the procedure returns to the processing in S309 without performing a touch input again. Otherwise, the procedure returns to the processing in S303 again, in which the user performs a touch input by touching a position that is to be focused on. Thereafter, the processing from S304 to S307 is repeated.

In S309, the learning data generation apparatus 200 determines whether the user has performed a release operation. In a case where a release operation has been performed, the image capturing unit 201 performs image capturing, and the procedure proceeds to the processing in S310. In a case where a release operation has not been performed, the procedure returns to the processing in S308, in which whether the user has performed a touch input again is determined again.

In S310, based on the focus position information saved in S304, the learning data generation unit 204 adds annotation information to the image saved in S304, thereby generating learning data. For example, the saved focus position information is added as the annotation information to the image, thereby generating learning data. Thus, a series of processing shown in FIG. 3 ends.

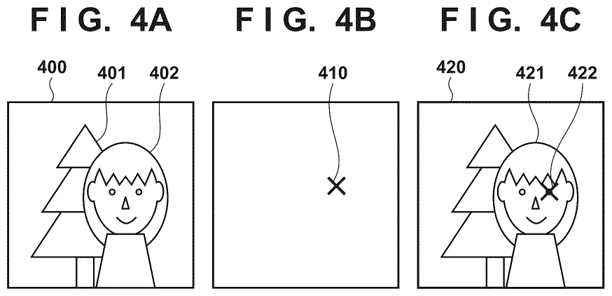

Here, FIGS. 4A to 4C are diagrams illustrating the learning data generation processing in S310. FIG. 4A represents an image 400 saved in S304. Reference numeral 401 denotes an object, and reference numeral 402 denotes a person. FIG. 4B is a diagram in which the coordinates of the touch input that are the focus position information saved in S304 are visualized. A marker denoted by 410 is a representation of the coordinates of the touch input during touch AF that have been saved in S304. FIG. 4C is a diagram in which the coordinates of the touch input that are the focus position information saved in S304 are superimposed on the image saved in S304. On a person 421 in an image 420, coordinates 422 of the position touched by the user are visualized as a marker. For example, FIG. 4C shows that, through the touch input performed by the user, the coordinates indicating a pupil of the person 421 are determined as the annotation information.

As described thus far, according to the present embodiment, performing normal image capturing using the image capturing unit makes it possible to collect image data for estimating the focus position information, and the annotation information. Accordingly, the user can collect image data and perform annotation without paying any attention, and it is therefore possible to reduce the time and effort to generate learning data.

### <Learning Method According to First Embodiment>

Using the learning data generated by the learning data generation processing according to the present embodiment, it is possible to train a machine learning model for estimating the focus position information.

Examples of specific algorithms of machine learning include a nearest neighbor algorithm, a Naive Bayes algorithm, a decision tree, and a support vector machine. Another example is deep learning in which feature amounts and combine-weighting coefficients for learning are self-generated using a neural network. As appropriate, those that can be used from among the above-described algorithms can be used and applied to the present embodiment.

Here, learning using a neural network will be described. Learning is performed using, as input data, the image saved in S304. In learning, error detection processing and weight update processing are performed.

The error detection process obtains an error between output data output from an output layer of the neural network according to input data input to an input layer, and teaching data. At this time, the focus position information saved in S304 is used as the teaching data. The focus position information represents the coordinates of a touch position during touch AF, for example. In the error detection processing, a loss function may be used to calculate the error between the output data from the neural network and the teaching data.

In the weight update processing, based on the error obtained by the error detection process, combine-weighting coefficients or the like between nodes of the neural network are updated such that the error becomes smaller. The weight update processing can be performed by updating the combine-weighting coefficients or the like using backpropagation, for example. Backpropagation is a method for adjusting combine-weighting coefficients or the like between nodes of neural networks such that the above-described error becomes smaller.

The output data output as a result of learning is a machine learning model for estimating the focus position information. The machine learning model refers to parameters such as a weighting coefficient obtained by the weight update processing.

By using an image as the input data and the focus position information as the teaching data in this manner, it is possible to train a neural network for regressing the focus position information according to the input image.

### <Inference Method According to First Embodiment)

The inference of the focus position information can be performed using a machine learning model that has been trained by the above-described learning method. Here, a description will be given of a case where inference has been performed by applying the trained machine learning model to a lens-replaceable digital camera.

As the input data, a live-view image captured using, for example, an imaging element such as a CMOS sensor is used. After obtained, the live-view image is directly used as input data for the trained machine learning model.

The output data is an inference result, and an estimated value of the focus position information is output. The output data represents, for example, estimated coordinates of a touch position during touch AF, and indicates information of coordinates within the image, such as a position (310, 452).

In this manner, when a user performs image capturing using a lens-replaceable digital camera, it is possible to use the trained machine learning model to estimate the focus position information included in the learning data from the live-view image. In a case where a subject included in the learning data is present in the live-view image, the AF frame in the image can be automatically selected without any input operation such as the touch AF, thus making it possible to reduce the time and effort during image capturing.

At the time of capturing an image of the subject included in the learning data, even in a case where it is difficult for the user to select the AF frame due to fast movement of the subject, the AF frame can be automatically selected from the image, and therefore the user can easily focus on the subject on which the user wishes to focus.

### Modification 1

With a smartphone, an AF target is frequently selected by touching the screen. The following describes, as a modification of the first embodiment, a case where the first embodiment is applied to a smartphone. In the present modification, a case will be described where a plurality of pieces of learning data are simultaneously generated by a single execution of processing for a smartphone including a plurality of lenses having different angles of view as an apparatus including a plurality of image capturing sensors.

For example, in a case where the smartphone has three lenses, namely, a telephoto lens, a standard lens, and a wide-angle lens, an image capturing unit (an imaging element or the like such as a CMOS sensor) is disposed for each of the lenses, and capturing operations through the respective lenses are performed simultaneously. The telephoto lens has a focal length longer than that of the standard lens, and is capable of capturing an enlarged image of a more distant subject. The wide-angle lens has a focal length shorter than the focal length of the standard lens, and therefore, the use of the wide-angle lens enables capturing an image over a larger range that the use of the standard lens.

That is, the focal length decreases in the order of the telephoto lens, the standard lens, and the wide-angle lens, and the capturing angle of view increases accordingly. Here, it is assumed that each of the telephoto lens, the standard lens, and the wide-angle lens is a lens having a zoom function, and capable of continuously changing capturing angles of view between the telephoto side and the wide-angle side. The telephoto lens, the standard lens, and the wide-angle lens may be lenses having not only a mechanism for optically magnifying an image by a predetermined magnification, but also a mechanism that allows the user to change the magnification.

A plurality of live-view images captured by the lenses can be checked on the display of the smartphone. The user performs image capturing while checking the plurality of live-view images displayed on the display.

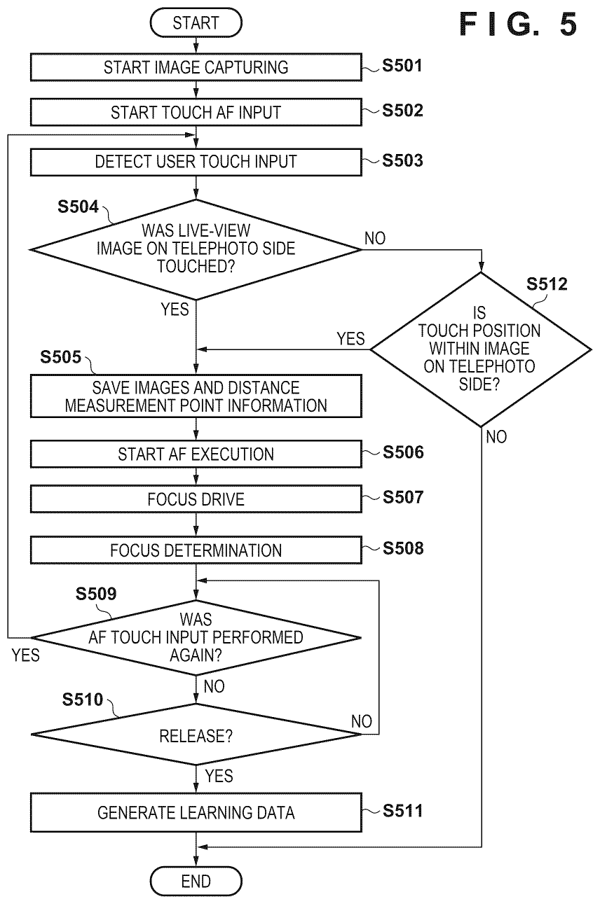

The processing according to the present modification is the same as the processing shown in FIG. 3 of the first embodiment, and therefore the basic description thereof has been omitted. Since the present modification differs from the first embodiment with regard to the processing in S304, the difference will be described in detail with reference to the flowchart of FIG. 5.

FIG. 5 is a flowchart illustrating an overall processing procedure of the learning data generation processing according to Modification 1. Since the processing from S501 to S503 is the same as the processing from S301 to S303 in FIG. 3, the description thereof has been omitted.

In S304, the focus position information obtaining unit 202 obtains the coordinates (focus position information) of the touch input that have been input in S303. The image obtaining unit 203 saves the live-view image obtained by the image capturing unit 201 at the moment when the touch input was performed in S303.

In S504, the input unit 140 determines whether the user has performed the touch input on the live-view image of the lens having the longest focal length. If the determination in this step is Yes, the procedure proceeds to S505. On the other hand, if the determination in this step is No, the procedure proceeds to S512.

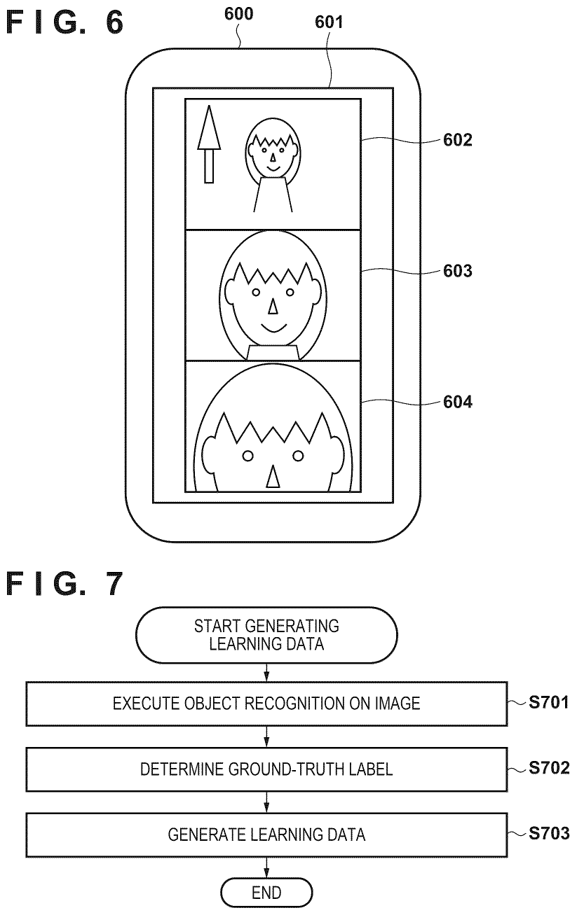

Here, FIG. 6 shows a result of displaying a live-view image 604 of a telephoto lens, a live-view image 603 of a standard lens, and a live-view image 602 of a wide-angle lens on a display 601 of a smartphone 600. For example, in a case where the user has touched the live-view image 604 of the telephoto lens in S504, the procedure proceeds to the processing in S505.

For example, in a case where the user has touched the live-view image 602 of the wide-angle lens, the procedure proceeds to the processing in S512. In a case where a touch input has been performed on the live-view image 602 of the wide-angle lens, which has a short focal length, at a touch position located at an end of the screen, the live-view image of the lens having a long focal length has a narrower angle of view, and therefore the focus position information may not fit in the image. In a case where the focus position information does not fit in the image, it may not be possible to generate learning data. For this reason, the determination processing in S504 is performed.

In S505, the focus position information obtaining unit 202 obtains the coordinates of the touch input that have been input in S503. The image obtaining unit 203 saves two or more live-view images captured simultaneously with two or more of the three lenses, i.e., the telephoto lens, the standard lens, and the wide-angle lens.

The processing from S506 to S511 is the same as the processing from S305 to S310 on FIG. 3, and therefore the description thereof has been omitted.

In S512, in a case where a touch input has been performed on the live-view image of the wide-angle lens, the input unit 140 determines whether the touch position fits within the image range of the telephoto lens. If the determination in this step is Yes, the procedure proceeds to S505. On the other hand, if the determination in this step is No, the processing ends.

This is the processing executed taking into account the following case: In a case where a touch input has been performed on the live-view image of the wide-angle lens, which has a short focal length, at a touch position located at an end of the screen, the angle of view of the live-view image of a lens having a long focal length is narrow, and therefore the focus position information does not fit in the image. Even in a case where a touch input has been performed on the live-view image of the wide-angle lens, a plurality of pieces of learning data can be simultaneously generated when the touch position fits within the image range of the telephoto lens. For this reason, the above-described determination process is performed.

It is assumed that f1 represents the focal length of the wide-angle lens, f2 represents the focal length of the telephoto lens, w1 represents the lateral resolution of the live-view image of the wide-angle lens, and h1 represents the longitudinal resolution thereof. In this case, it is assumed that, on the live-view image of the telephoto lens, lateral Aw and longitudinal Δh represent resolutions of a region corresponding to the angle of view with respect to the center of the image. Here, Δw and Δh are defined by the following equations (1) and (2):

$$Δ w = w 1 \cdot f 1 / f 2 \qquad ( 1 )$$

$$Δ h = h 1 \cdot f 1 / f 2 \qquad ( 2 )$$

Accordingly, assuming that, on the live-view image of the wide-angle lens, w2 and h2 respectively represent the lateral resolution and the longitudinal resolution with which a touch input fits within the range of the live-view image of the telephoto lens, the ranges of values of w2 and h2 are defined by the following equations (3) and (4):

$$( w 1 - Δ w ) / 2 \leq w 2 \leq ( w 1 + Δ w ) / 2 \qquad ( 3 )$$

$$( h 1 - Δ h ) / 2 \leq h 2 \leq ( h 1 + Δ h ) / 2 \qquad ( 4 )$$

For example, when f1=13, f2=26, w1=4032, and h1=3024, Δw=2016 and Δh=1512. The range of values of w2 is from 1008 to 3024, and the range of values of h2 is from 756 to 2268. However, since the lenses of the smartphone are not attached to exactly the same position, the center positions of the wide-angle lens and the telephoto lens may be displaced from each other by the amount of displacement between their attached positions. Therefore, the ranges of values of w2 and h2 may be corrected according to the displacement amount. In a case where the coordinates at which the live-view image of the wide-angle lens has been touched are included in the ranges of w2 and h2, the procedure proceeds to the processing in S505. Otherwise, the learning data generation processing ends.

Thus, in the case of a smartphone including a plurality of lenses having different angles of view, a plurality of pieces of learning data with different angles of view can be simultaneously collected by a single execution of processing, and it is therefore possible to efficiently increase variations of learning data.

### Modification 2

In the above-described embodiment, only the live-view image captured at the moment when a touch input was performed in S304 is saved. However, one or more live-view images may be further saved at any other timing. For example, the timing of saving may be, for example, immediately after the in-focus determination in S307.

For example, in the case of capturing an image of a moving subject, increasing the number of timings of saving live-view images in this manner makes it possible to include any movement or change of the subject occurring in a short time between a touch input and focusing in the image. In addition, variations of captured images can be increased, thus making it possible to increase the number of pieces of learning data that can be acquired by a single execution of processing.

### Second Embodiment

In the present embodiment, a description will be given of an example in which learning data for detecting a main subject present at the user's desired focus position.

### <Functional Configuration>

FIG. 8 is a diagram illustrating a learning data generation apparatus 200 according to the present embodiment. An image capturing unit 201, a focus position information obtaining unit 202, and an image obtaining unit 203 of the present embodiment are the same as those of the first embodiment, and therefore the descriptions thereof have been omitted.

A learning data generation unit 204 according to the present embodiment includes an object recognition unit 2041, and object recognition is performed on an image obtained by the image obtaining unit 203. Here, object recognition processing is processing including at least one of object detection and region segmentation. The region segmentation may be semantic region segmentation in which class classification is performed for each pixel.

Object detection processing is a task of detecting a specific object (a person, a dog, a vehicle, or the like) or a specific portion (a face, a pupil, a head, or the like) from an image. In the object detection processing, the position and size of a detection target are estimated, and the result of the estimation is output in the form of a rectangle (bounding box).

Region segmentation processing is a task of identifying the class for each pixel in an image, and classifying the image into regions according to the classes. Examples of the region segmentation process include semantic segmentation in which class classification is performed on all pixels in an image, and instance segmentation in which, in addition to class classification, classification for each object in an image is performed. Specific methods of object detection and region segmentation are described in Kaiming He et al. “Mask R-CNN”, and the descriptions of the methods themselves have been omitted in the present embodiment.

The object recognition unit 2041 in the present embodiment is a previously trained neural network. Any learning model that can perform object recognition may be used without any particular limitation. Data that is input to the object recognition unit 2041 is an image obtained by the image obtaining unit 203.

### <Processing>

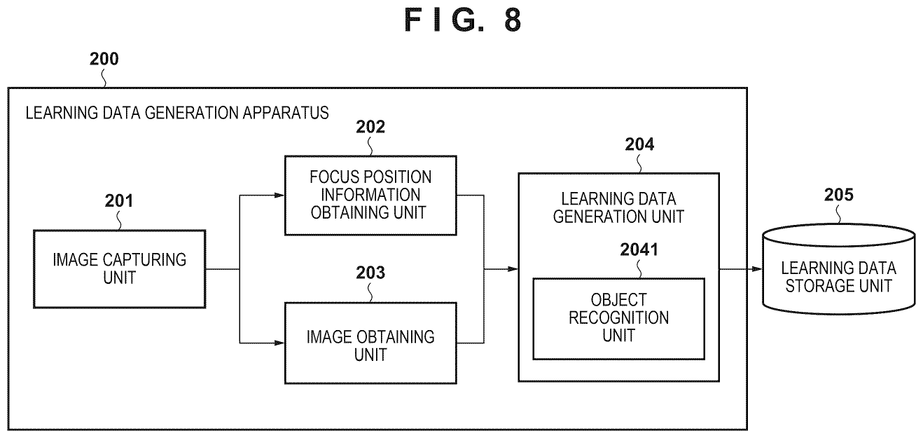

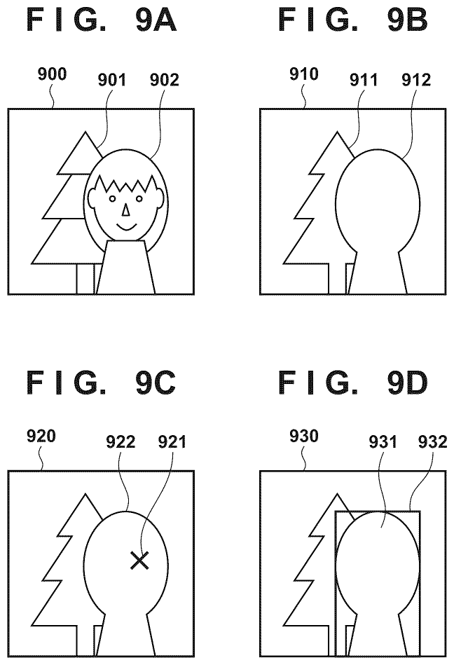

The processing in the present embodiment is the same as the processing in FIG. 3 described in the first embodiment, and therefore the basic description thereof has been omitted. The processing in S310 differs from that in the first embodiment. FIG. 7 is a flowchart illustrating a procedure of learning data generation processing according to the present embodiment, and the detailed processing procedure according to the present embodiment that correspond to the processing in S310 are shown. Here, a description will be given with additional reference to FIGS. 9A to 9D, taking instance segmentation as an example.

In S701, the object recognition unit 2041 performs object recognition on an image obtained by the image obtaining unit 203. FIG. 9A shows that an object 901 (tree) and a subject 902 (person) are captured in an image 900 obtained by the image obtaining unit 203. The object recognition unit 2041 performs instance segmentation on this image. FIG. 9B shows an output result 910 of performing instance segmentation on the image 900. Class A911 and class B912 are classified for each pixel as the output result. Here, the class A indicates, for example, a tree, and the class B indicates, for example, a person.

In S702, based on the coordinates obtained by the focus position information obtaining unit 202, the learning data generation unit 204 determines an object to be set as a main subject from the result of the recognition performed by the object recognition unit 2041. FIG. 9C shows coordinates 921 of the focus position information obtained by the focus position information obtaining unit 202 that are superimposed on an output result 920 of performing instance segmentation. In the output result 920, the class to which the coordinates indicated by the coordinates 921 of the focus position information belongs to is determined as a main subject on the image. Here, class B922 is determined as a main subject.

In S703, the learning data generation unit 204 recognizes the information of the main subject determined in S702 as a ground-truth label of the object detection, and adds the ground-truth label as annotation information associated with the main subject, thereby generating learning data. FIG. 9D shows a result of creating learning data for detecting the main subject on the image by enclosing, by a circumscribing rectangle 932, pixels of class B931 to which the main subject on the image determined in S702 belongs.

For the class label of the created data, the class of the main subject determined in S702 may be used. The class label of the learning data may be set by accumulating a plurality of pieces of created learning data and clustering the pieces of data.

According to the present embodiment, image data for main subject detection and annotation information can be collected by performing normal image capturing using the image capturing unit. This makes it possible to reduce the time and effort to generate learning data, including collecting image data.

### <Learning Method According to Second Embodiment>

Using the learning data generated by the learning data generation processing according to the present embodiment, it is possible to train a machine learning model for object detection.

Examples of the specific algorithms of machine learning include deep learning in which feature amounts and combine-weighting coefficients for learning are self-generated using a neural network. Here, learning using a neural network will be described.

Learning is performed using the image saved in S304 as input data. In the learning, error detection processing and weight update processing are performed. The error detection processing obtains an error between output data output from an output layer of the neural network according to input data input to an input layer, and teaching data. At this time, as the teaching data, the circumscribing rectangle 932 saved in S703 is used as a bounding box obtained as a result of estimating the position and size of an object. In the error detection processing, a loss function may be used to calculate the error between the output data from the neural network and the teaching data.

In the weight update processing, based on the error obtained by the error detection process, combine-weighting coefficients or the like between nodes of the neural network are updated such that the error becomes smaller. In the weight update processing, the combine-weighting coefficients or the like are updated using backpropagation, for example. Backpropagation is a method for adjusting combine-weighting coefficients or the like between nodes of neural networks such that the above-described error becomes smaller.

The output data output as a result of learning is a machine learning model for estimating a bounding box that defines the position and size of an object. The machine learning model refers to parameters such as a weighting coefficient obtained by the weight update processing.

By using an image as the input data and a bounding box that defines the position and size of an object as the teaching data in this manner, it is possible to train a neural network for performing object detection from the input image.

### <Inference Method According to Second Embodiment>

The inference of object detection can be performed using a machine learning model that has been trained by the above-described learning method. Here, a description will be given of a case where inference has been performed by applying the trained machine learning model to a lens-replaceable digital camera.

As the input data, a live-view image captured using, for example, an imaging element such as a CMOS sensor is used. After obtained, the live-view image is directly used as input data for the trained machine learning model.

The output data is an inference result, and a bounding box obtained as a result of estimating the position and size of an object is output. The output data represents, for example, the position and the size in accordance with the spatial direction of the image, such as in the order of the lateral coordinate, the longitudinal coordinate, the lateral size, and the longitudinal size (310, 452, 105, 40) of the image.

In this manner, when a user performs image capturing using a lens-replaceable digital camera, the user can use the trained machine learning model to estimate the position and size of an object included in the learning data from the live-view image. In a case where an image of a subject included in the learning data is to be captured, the user can automatically detect the subject and focus on the subject without selecting the AF frame through an input operation such as touch AF within the image, thus making it possible to reduce the time and effort for inputting.

### Third Embodiment

In the present embodiment, a description will be given of an example in which learning data for estimating the defocus amount of the user's desired focus position is created from a defocus map.

First, the defocus map will be described. The defocus map is a map obtained by mapping defocus amounts at a plurality of locations on input image data. A defocus amount is represented in units of Fδ. For the generation of a defocus map, a known pupil division type phase difference detection method can be used. For example, correlation calculation is performed for each of the image signals in two different pupil regions, and the phase difference, which is the amount of displacement between images having different parallaxes (hereinafter referred to as A image and B image), or in other words, the amount of displacement between the A image and the B image, is calculated. Then, the defocus amount is calculated based on the calculated phase difference (amount of displacement) between the A image and the B image, thereby generating a defocus map.

### <Functional Configuration>

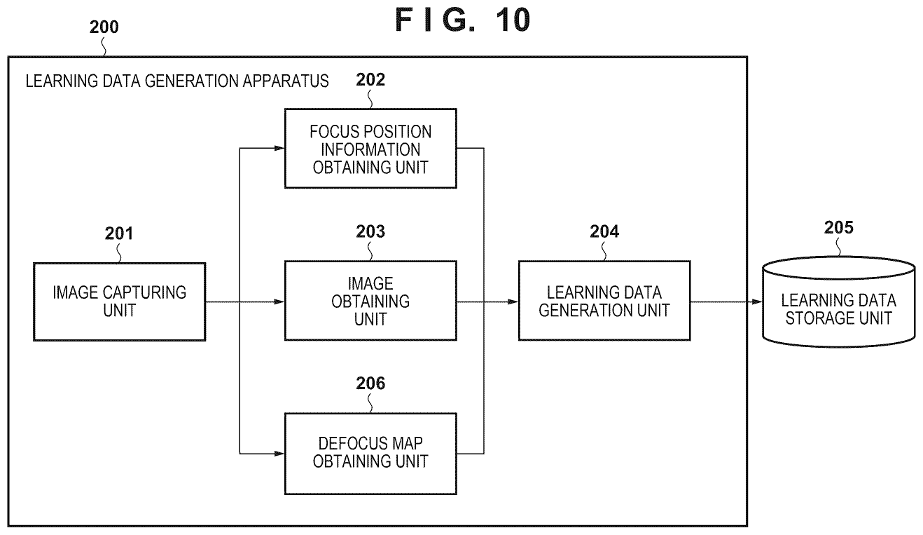

FIG. 10 is a diagram illustrating the functional configuration of a learning data generation apparatus 200 according to the present embodiment. An image capturing unit 201, a focus position information obtaining unit 202, an image obtaining unit 203, a learning data generation unit 204, and a learning data storage unit 205 according to the present embodiment are the same as those shown in FIG. 2, and therefore the basic descriptions thereof have been omitted.

A defocus map obtaining unit 206 obtains a defocus map that is time-synchronized with the image obtained by the image obtaining unit 203.

### <Processing>

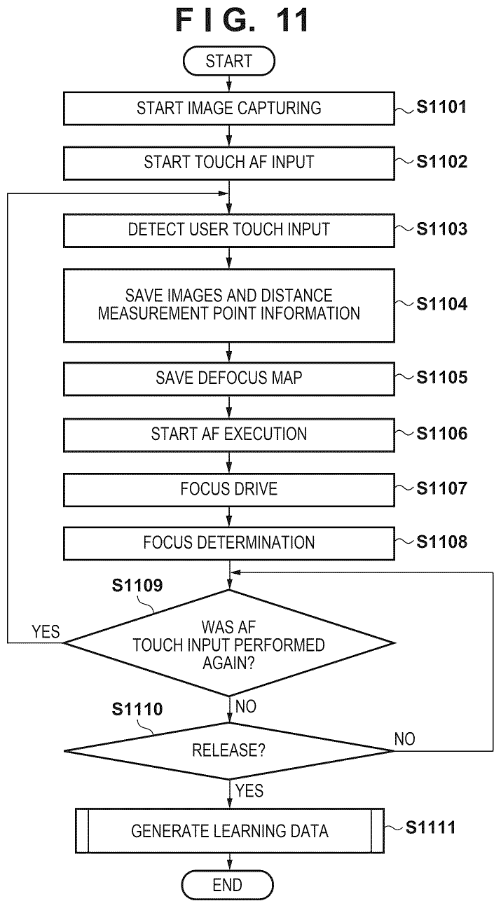

FIG. 11 is a flowchart illustrating a procedure of learning data generation processing according to the present embodiment. The processing performed in S1105 and the processing performed in S1111 that corresponds to the processing in S310 differ from the corresponding processing in the first embodiment, and therefore the description will focus on the differences.

The processing from S1101 to S1104 is the same as the processing from S301 to S304 shown in FIG. 3, and therefore the description thereof has been omitted. In S1105, the defocus map obtaining unit 206 obtains a defocus map that is time-synchronized with the image obtained in S1104, and saves the defocus map. The processing from S1106 to S1110 is the same as the processing from S305 to S309 in FIG. 3, and therefore the description thereof has been omitted. In S1111, the learning data generation unit 204 generates learning data from the defocus map obtained in S1105.

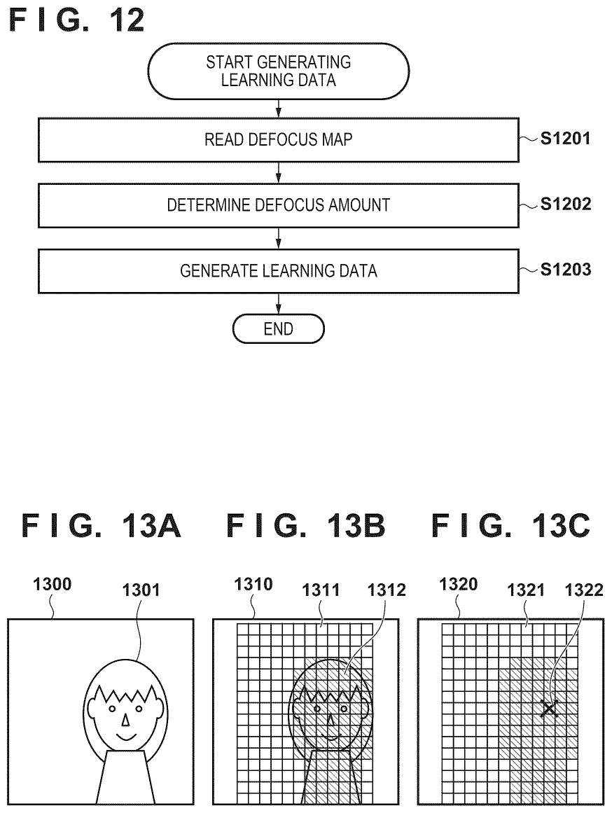

Here, the details of the processing in S1111 will be described with reference to FIG. 12. In S1201, the learning data generation unit 204 reads the defocus map obtained in S1105. In S1202, the learning data generation unit 204 determines the defocus amount of the main subject from the defocus map obtained in S1105.

Here, FIGS. 13A to 13C are diagrams illustrating the process of determining, from the values on the defocus map read in S1201, the defocus amount of an object to be set as a main subject, based on the focus position information, and generating learning data. FIG. 13A shows that a subject 1301 (person) is captured in an image 1300 obtained in S1104.

FIG. 13B is an image obtained as a result of a defocus map 1311 read in S1201 being superimposed on an image 1310 obtained in S1104. The defocus map 1311 shows that the darker the color of a region, the larger the defocus amount of the region is, and the region in which a subject 1312 is present shows a defocus amount larger than the defocus amount shown by the background.

FIG. 13C is a result 1320 of visualizing and superimposing focus position information 1322 saved in S1104 on a defocus map 1321. The defocus amount on the coordinates indicated by the focus position information 1322 on the defocus map 1321 is determined as annotation information. At this time, the determined defocus amount is, for example, 0.1 Fδ.

In S1203, the learning data generation unit 204 generates learning data using the defocus amount determined in S1202 as the annotation information. In the present embodiment, learning data in which the defocus amount of the main subject determined in S1202 is added to the image saved in S1104 as the annotation information is generated.

According to the present embodiment, image data for defocus amount estimation and annotation information can be collected by performing image capturing using the image capturing unit. This makes it possible to reduce the time and effort to generate learning data, including collecting image data.

### <Learning Method According to Third Embodiment>

Using the learning data generated by the learning data generation processing according to the present embodiment, it is possible to train a machine learning model for estimating the defocus amount.

Examples of the specific algorithms of machine learning include deep learning in which feature amounts and combine-weighting coefficients for learning are self-generated using a neural network. Here, learning using a neural network will be described.

Learning is performed using the image saved in S304 as input data. In the learning, error detection processing and weight update processing are performed. The error detection processing obtains an error between output data output from an output layer of the neural network according to input data input to an input layer, and teaching data. At this time, as the teaching data, the defocus amount saved in S1203 is used. In the error detection processing, a loss function may be used to calculate the error between the output data from the neural network and the teaching data.

In the weight update processing, based on the error obtained by the error detection process, combine-weighting coefficients or the like between nodes of the neural network are updated such that the error becomes smaller. In the weight update processing, the combine-weighting coefficients or the like are updated using backpropagation, for example. Backpropagation is a method for adjusting combine-weighting coefficients or the like between nodes of neural networks such that the above-described error becomes smaller.

The output data output as a result of learning is a machine learning model for estimating the defocus amount of the main subject. The machine learning model refers to parameters such as a weighting coefficient obtained by the weight update processing.

By using an image as the input data and a defocus amount as the teaching data in this manner, it is possible to train a neural network for estimating the defocus amount according to the input image.

### <Inference Method According to Third Embodiment>

The inference of the defocus amount of the main subject can be performed using a machine learning model that has been trained by the above-described learning method. Here, a description will be given of a case where inference has been performed by applying the trained machine learning model to a lens-replaceable digital camera.

As the input data, a live-view image captured using, for example, an imaging element such as a CMOS sensor is used. After obtained, the live-view image is directly used as input data for the trained machine learning model. The output data is an inference result, and an estimated value of the defocus amount of the main subject is output. The output data is, for example, 0.13 Fδ.

In this manner, when a user performs image capturing using a lens-replaceable digital camera, the user can use the trained machine learning model to estimate the defocus amount of the main subject included in the learning data from the live-view image. In a case where an image of a main subject included in the learning data is to be captured, the user can automatically determine the main subject and estimate the defocus amount thereof without selecting an AF frame through an input operation such as touch AF. Consequently, the time and effort during image capturing can be reduced, and the main subject included in the learning data can be easily focused on by performing AF using the defocus amount obtained as a result of the estimation.

According to the present disclosure, it is possible to reduce the time and effort to generate learning data.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-087244, filed May 29, 2024, which is hereby incorporated by reference herein in its entirety.

What is claimed is:

1. An information processing apparatus that generates learning data, the apparatus comprising:
a position information obtaining unit configured to obtain focus position information of an image capturing unit;
an image obtaining unit configured to obtain one or more images based on a point in time at which the focus position information was obtained;
a defocus information obtaining unit configured to obtain defocus information at a point in time that is in temporal proximity to the point in time at which the focus position information was obtained; and
a generation unit configured to determine, based on the defocus information obtained by the defocus information obtaining unit, a defocus amount of an object to be set as a main subject, and generate the learning data in which the defocus amount of the main subject is added as annotation information to the one or more images obtained by the image obtaining unit.

2. The information processing apparatus according to claim 1, wherein
the focus position information represents coordinates indicating a position of a distance measurement point that is selected within an angle of view of the image capturing unit.

3. The information processing apparatus according to claim 2, further comprising
a display unit configured to display an image located within the angle of view of the image capturing unit, wherein
the position of the distance measurement point is a position selected by a user on the image located within the angle of view of the image capturing unit.

4. The information processing apparatus according to claim 1, wherein
the one or more images are live-view images.

5. The information processing apparatus according to claim 1, further comprising
an object recognition unit configured to recognize a learned object, wherein
the generation unit is configured to:
determine, based on the focus position information, an object to be set as a main subject from a result of the recognition performed by the object recognition unit; and
generate the learning data in which the annotation information associated with the main subject is added to the one or more images obtained by the image obtaining unit.

6. The information processing apparatus according to claim 5, wherein
the object recognition unit is configured to execute processing of at least one of object detection and region segmentation.

7. The information processing apparatus according to claim 6, wherein
the region segmentation includes instance segmentation.

8. The information processing apparatus according to claim 1, wherein
the one or more images are images at a point in time that is in temporal proximity to the point in time at which the focus position information was obtained.

9. The information processing apparatus according to claim 1, wherein
the image capturing unit includes a plurality of lenses having different angles of view,
the plurality of lenses include a lens having a first angle of view, and a lens having a second angle of view that is wider than the first angle of view, the information processing apparatus further comprises:
a display unit configured to display a first image obtained with the lens having the first angle of view, and a second image obtained with the lens having the second angle of view; and
a determination unit configured to determine whether the focus position information selected on the second image is included within the first image, and
the generation unit is configured to, in a case where the focus position information selected on the second image is included within the first image, add, based on the focus position information, the annotation information to the first image and the second image, thereby generating the learning data.

10. The information processing apparatus according to claim 1, wherein
the generation unit is configured to add the focus position information as the annotation information.

11. The information processing apparatus according to claim 1, wherein
the generation unit is configured to generate the learning data in which the defocus amount at coordinates indicated by the focus position information is added as the annotation information.

12. A control method of an information processing apparatus that generates learning data, the method comprising:
obtaining focus position information of an image capturing unit;
obtaining one or more images based on a point in time at which the focus position information was obtained;
obtaining defocus information at a point in time that is in temporal proximity to the point in time at which the focus position information was obtained; and
determining, based on the obtained defocus information, a defocus amount of an object to be set as a main subject, and generating the learning data in which the defocus amount of the main subject is added as annotation information to the obtained one or more images.

13. A non-transitory computer-readable storage medium having stored therein a program for causing a computer to execute a control method of an information processing apparatus that generates learning data, the method comprising:
obtaining focus position information of an image capturing unit;
obtaining one or more images based on a point in time at which the focus position information was obtained;
obtaining defocus information at a point in time that is in temporal proximity to the point in time at which the focus position information was obtained; and
determining, based on the obtained defocus information, a defocus amount of an object to be set as a main subject, and generating the learning data in which the defocus amount of the main subject is added as annotation information to the obtained one or more images.
